(19) United States
(12) Patent Application Publication
(10) Pub. No.: US 2006/0098618 A1
(43) Pub. Date: May 11, 2006

(54) Method and bridging device for priortizing transfer of data streams

(75) Inventor: Alain Rene Paul Bouffioux, Leuven (BE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/543,395

(22) PCT Filed: Dec. 16, 2003
(86) PCT No.: PCT/IB03/06333

§ 371 Date: Jul. 26, 2005

(30) Foreign Application Priority Data
Jan. 31, 2003 (EP) 031002066

(51) Int. Cl. H04J 3/24; H04J 3/18; H04J 1/00

(52) U.S. Cl. 370/349; 370/489; 370/477

(57) ABSTRACT

The invention relates to a method, bridging device (10), network of devices as well as a computer program product and computer program element for prioritizing transportation of isochronous data streams from a first bus (16) having a first band-width to a second bus (18) using a medium (13) having a second medium bandwidth lower than the first bandwidth. The bridging device monitors control traffic relating to data streams originating from devices (20, 22) connected to the buses, polls the registers made available by the devices connected to the buses, prioritizes streams for transfer based on relevant information transported in the bus control traffic and/or made available by the devices connected to a bus and transfers streams over the medium based on the prioritizing. The invention enables prioritizing streams for transportation over a wireless bridge between two data buses that is transparent to devices connected to the buses.

The present invention generally relates to the field of transferring data streams from a first device located on a first bus to a second device located on a second bus via a limited size medium and more particularly to a method, a bridging device, a network of devices as well as a computer program product and a computer program element for prioritizing of data streams transferred from the first bus via the medium.

It is well known to provide a network of computing devices connected via buses. It is known to provide such networks including several buses communicating with each other, such that data streams can be transferred from one bus to the other via a bridging device.

One such system is described in “Transparent Bridge for IEEE1394 Networks with Hiperlan2 Interconnection between IEEE1394 Portals”, by Alain Bouffioux, Sébastien Perrot, Lothar Stadelmeier, Denis Mischler and Norbert Philips, IEEE International Symposium on Consumer Electronics 2002, Wireless Consumer Devices and Services, 24-26 Sep. 2002. Here two buses of the IEEE 1394 type are interconnected. In order to interconnect the two buses a bridging device including two portals and one wireless medium is used. The bridge is here transparent in that the devices on the buses believe they are connected to one common bus. The document also mentions that only relevant traffic is forwarded from a bus over the wireless medium, but is silent on how this selection takes place.

If the medium of the bridging device has a lower capacity or bandwidth than the buses it interconnects, which can for instance be the case when the medium is wireless, there has to be some means provided for deciding which data streams are to be transferred from one bus to the other in case the traffic load on the buses is too high to be fully transferred through the wireless medium.

There is thus a need for a way of prioritizing the transfer of data streams between the two buses via a medium, when the medium over which the transfer takes place has a lower capacity than the buses and to do this in a way that is transparent to devices connected to the buses.

It is an object of the present invention to provide prioritizing of the transfer of data streams from a first device located on a first bus to a second device located on a second bus using a medium, when the medium over which the transfer takes place has a lower capacity than the first bus and to do this in a way that is transparent to devices connected to the buses.

According to a first aspect of the present invention, this object is achieved by a method of prioritizing transportation of isochronous data streams appearing on at least a first bus of a first type having a first bandwidth to a second bus using a medium having a second medium bandwidth lower than the first bandwidth, comprising the steps of:

monitoring control traffic relating to data streams originating from devices connected to the buses and/or polling or ordering the polling of the devices connected to the buses,

prioritizing streams for transfer over the medium based on relevant information transported in the bus control traffic and/or made available by the devices connected to the buses, and

transferring streams over the medium based on the prioritizing.

According to a second aspect of the present invention, this object is also achieved by a bridging device for prioritizing of transportation of isochronous data streams appearing on at least a first bus of a first type having a first bandwidth from devices connected to the first bus to devices connected to a second bus using a medium having a second medium bandwidth lower than the first bandwidth, said bridging device comprising:

at least one first portal comprising:
a medium transceiving unit for transmitting/receiving data streams over the medium,
a first bus transceiving unit for transmitting/receiving data streams over the first bus, and
a control unit arranged to:
   monitor control traffic relating to data streams originating from devices connected to the first bus and/or poll or order the polling of the devices connected to the buses,
   prioritize streams for transfer over the medium based relevant information transported in the bus control traffic and/or made available by the devices connected to the buses, and
   control transferring of streams over the medium based on the prioritizing.

According to a third aspect of the invention, the object is also achieved by a network of devices communicating with each other comprising:

a first bus of a first type having a first bandwidth,

at least one first device connected to the first bus,

at least one second device connected to a second bus and communicating with devices of the first bus using a medium having a second medium bandwidth lower than the first bandwidth, and

a bridging device connected between the first bus and the second bus and comprising:
at least one first portal comprising:
   a medium transceiving unit for transmitting/receiving data streams over the medium,
   a first bus transceiving unit, and
   a control unit arranged to:

monitor control traffic relating to isochronous data streams originating from devices connected to the first bus and/or poll or order the polling of the devices connected to the buses,

prioritize streams for transfer over the medium based on relevant information transported in the bus control traffic, and/or made available by the devices connected to the buses, and

control transferring of streams over the medium based on the prioritizing.

According to a fourth aspect of the present invention, the object is also achieved by a computer program element and a computer program product for prioritizing of transportation of isochronous data streams appearing on at least a first bus of a first type having a first bandwidth over a medium having a second medium bandwidth lower than the first bandwidth, to be used on a computer provided between said first bus and the medium, comprising a computer readable medium having thereon:

computer program code means, to make the computer execute, when said program is loaded in the computer:
monitor control traffic relating to data streams originating from devices connected to the first bus and/or poll or order the polling of the devices connected to the buses,
prioritize streams for transfer over the medium based on relevant information transported in the bus control traffic and/or made available by the devices connected to the buses, and
control transfer of streams over the medium based on the prioritizing.

Claims 2, 13 and 26 are directed towards prioritizing of streams to be transmitted to a second bus of the same type as the first bus via the medium.

Claims 4, 5, 15, and 16 are directed towards giving a certain priority to streams for which an intended receiver is known to be connected to another bus than the bus the sending device is connected to.

Claims 6 and 17 give a certain priority to streams that are broadcast, i.e. are intended for all devices, which the first bus is able to communicate with.

The present invention has the advantage of prioritizing transfer of streams without the devices having to request transfer or bandwidth from the bridging device. The invention is therefore transparent to the devices. This has the advantage that it works with legacy devices, that is with devices designed according to the present bus specification and already available on the market. This has also the additional advantage that the devices can be made simpler than they would otherwise need to be. These devices do therefore not have to know how prioritization is done.

The general idea behind the invention is thus to monitor control traffic and/or poll or order the polling of devices connected to the buses and prioritize transfer of streams from a bus over a limited size medium in dependence of relevant information transported in the bus control traffic and/or made available by devices connected to the buses.

These and other aspects of the invention will be apparent from and elucidated with reference to the embodiments described hereinafter.

The present invention will now be explained in more detail in relation to the enclosed drawings, where

FIG. 1 shows a schematic drawing of a network of devices connected to each other via two buses and a bridging device according to the invention,

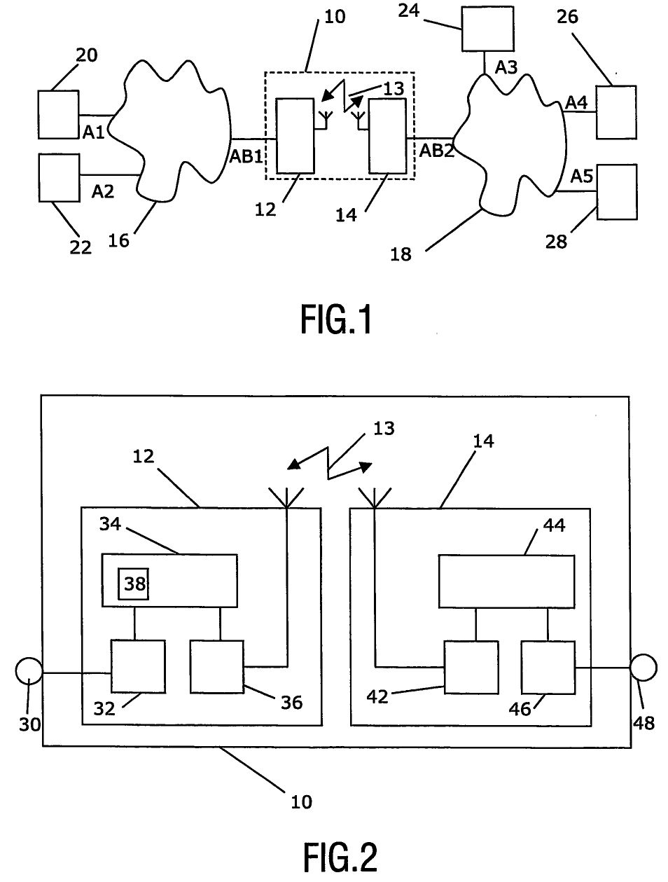

FIG. 2 shows a block schematic of the bridging device according to the invention,

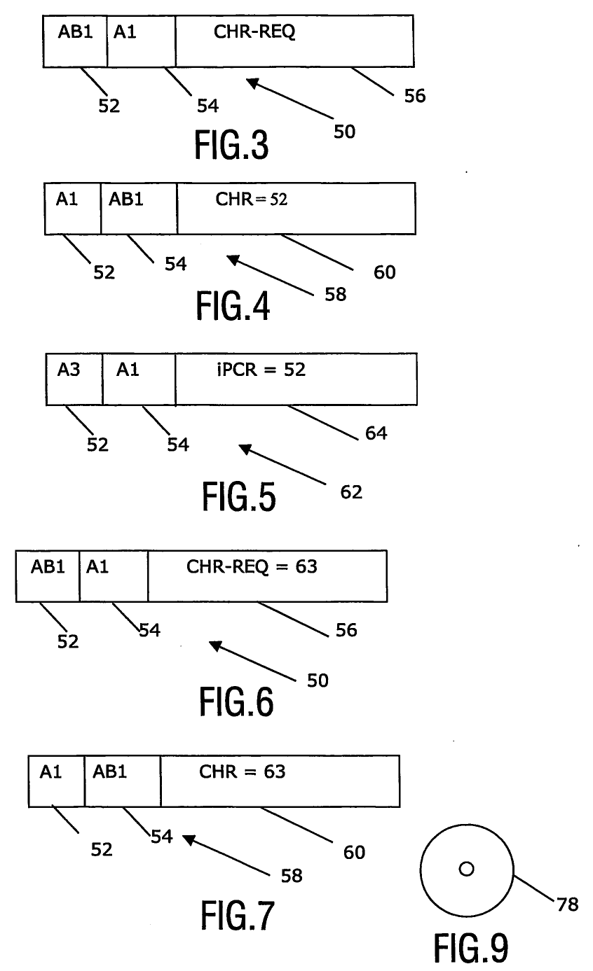

FIG. 3 schematically shows a first control traffic signal sent from a first device to an isochronous resource manager,

FIG. 4 schematically shows a second control traffic signal sent from the isochronous resource manager to the first device,

FIG. 5 schematically shows a third control traffic signal sent from the first device to another device,

FIG. 6 schematically shows a fourth control traffic signal sent from a first device to an isochronous resource manager,

FIG. 7 schematically shows a fifth control traffic signal sent from the isochronous resource manager to the first device,

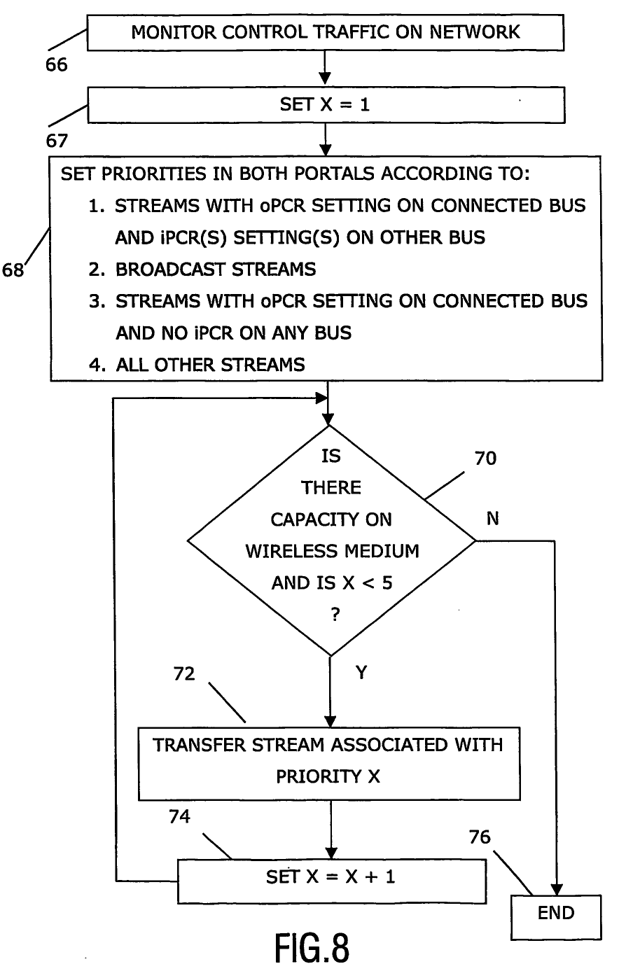

FIG. 8 shows a flow chart of a method of prioritizing between different types of streams according to the invention, and,

FIG. 9 schematically shows a computer readable medium on which is stored program code for performing the method according to the invention.

FIG. 1 shows a schematic drawing of the invention and its environment. In FIG. 1 there is shown a home network in the form of a bridging device 10 interconnecting a first bus 16 with a second bus 18. A first device 20 and a second device 22 are connected to the first bus 16 and a third 24, a fourth 26 and a fifth device 28 are connected to the second bus 18. These devices can be all types of devices that can be connected in a network in a home, like a PC, a video recorder, a television set or any other type of equipment connectable in a home network. Each of the devices is provided with an input Plug Control Register (iPCR) and an output Plug Control Register (oPCR) as defined in the IEC 61883-1 standard. The buses are in the preferred embodiment buses communicating using the IEEE 1394 protocol. The bridging device 10 includes a first portal 12 connected to the first bus 16 and a second portal 14 connected to the second bus 18. The first and second portals 12 and 14 communicate with each other with a wireless connection 13. They thus have a communication medium between each other, which is air in the preferred embodiment. In the figure the addresses used on the network are also indicated for each device, where the first device 20 has an address A1, the second device 22 an address A2, the third device 24 an address A3, the fourth device 26 and address A4, the fifth device 28 an address A5 and the bridging device has addresses AB1 and AB2, where address AB1 is associated with the first portal 12 and address AB2 is associated with the second portal 14.

FIG. 2 shows a block schematic of the bridging device 10 according to the invention. As mentioned earlier, the bridging device includes two portals 12 and 14, where a first portal 12 includes a first terminal 30 for connection to the first bus. The first terminal 30 is connected to a first bus transceiving unit 32, which in turn is connected to a first control unit 34. The first control unit 34, including an isochronous resource manager 38, is connected to a first medium transceiving unit 36, which in turn is connected to an antenna for communication with the second portal 14 using the wireless medium 13. The second portal 14 includes a second medium transceiving unit 42 connected to an antenna for communication with the first portal 12. The second medium transceiving unit 42 is connected to a second control unit 44. The second control unit 44 is connected to a second bus transceiving unit 46, which is connected to a second terminal 48 for sending data on the second bus 18. It should furthermore be realized that the first and second portals 12 and 14 work in two directions, i.e. they can both send and receive streams to and from the bus they are connected to. The first and second control units 34 and 44 both include a prioritization function for the traffic issued from the IEEE1394 bus, that is, from the medium with the highest bandwidth. There is only one isochronous resource manager for all the 1394 buses the bridge interconnects. Every device or portal may access the isochronous resource manager to request a channel number and some bandwidth. The isochronous resource manager is elected during the configuration process and here the first portal was elected as such a manager. The second portal however emulates the resource manager in order to service devices connected to the second bus. The isochronous resource manager may be implemented by any device on one of the buses; it may also be implemented in the second portal instead of in the first portal and then the first portal would emulate the isochronous resource manager.

The bridge is furthermore transparent in the sense that any device connected on one of the buses sees only a single bus and thus a single set of isochronous channels managed by a single isochronous resource manager.

Now the method of allocating channels will be described with reference being made to FIG. 3-5. The figures are abstractions of the process used in order to provide an easier understanding of the invention. The actual principle used is based on a write lock transaction to the appropriate CSR (Command and Status Register) register of the isochronous resource manager. FIG. 3 shows an abstraction of a first control traffic signal 50. The signal 50 includes a destination address field 52 having the address of the isochronous resource manager 38, which here is AB1, since the first portal 12 was elected to provide the isochronous resource manager, and a source address field 54 having the address A1, the address of the first device as well as the field 56 indicating a channel request, here abstracted with the data CHR_REQ. This message is sent from the first device to the isochronous resource manager.

FIG. 4 shows an abstraction of a second control traffic signal 58 in the form of a reply to the channel request. This message is issued from the isochronous resource manager to the first device. This reply message 58 therefore includes a destination address field 52 having the address A1 of the first device, a source address field 54 having the address of the isochronous resource manager and a channel allocation field 60, which is abstracted here, for illustration purpose, by the string “CHR=52”, which means that a channel number 52 has been assigned to the first device.

FIG. 5 shows an abstraction of a third control traffic signal 62 in the form of a message from the first device ordering the third device to set its input Plug Control Register to the channel 52. The destination address field 52 therefore is set with the address A3, the source address field 54 is set with the address of the first device A1, and an iPCR field 64 is set with IPCR=52.

FIG. 6 shows an abstraction of a fourth control traffic signal 50 sent from the first device to the isochronous resource manager function. This fourth control traffic signal performs the same function as the first control traffic signal, i.e. it requests a channel, which is why this signal has the same reference numeral as the first signal. Therefore the destination and source address fields are identical with the source and destination address field of the first control message. The difference here is that the channel request field 56 is here set to CHR_REQ=63, a specific channel, channel 63, which is a broadcast channel.

FIG. 7 shows an abstraction of a fifth control traffic signal 58 sent from the isochronous resource manager to the first device. This message is very much similar to the second control traffic signal, the only difference being that the channel allocated to the first device is the broadcast channel 63.

In the bus structure the different devices are arranged to set up connections between each other by requesting a certain bandwidth on the bus to the isochronous resource manager function, which is accessible from any device located on the network, and by setting-up which device will transmit using the bandwidth allocated to the stream and which device or devices will receive the stream. In this regard each device in the network believes that it is only communicating on one bus and not on two different buses interconnected via a bridging device using a wireless connection. In this sense the bridging device is transparent to the devices and does not seem to exist to them. How to set up connections and to request bandwidth is for example described in the IEC specification 61883-1. A controller can set up a connection between two devices, where such a controller can be provided in one of the devices or can be a separate entity on the bus network.

Normal operation of the present invention will now be described with reference being made to FIGS. 1, 2, 3, 4, 5, 6, and 7. In case, for example, the first device 20 includes a controller and wants to send a data stream to another device it requests a channel and the needed bandwidth to the isochronous resource manager function by sending the first control traffic signal 50. If there is space available on the network, the device is allocated such a channel, for instance channel 52. When done, the requesting device 20 is informed of the allocation by the second control traffic signal 58 received from the isochronous resource manager and sets its oPCR to this channel. The setting of the oPCR can also be done by any controller device located on a 1394 network. In order for a device to receive a stream, any controller should set the iPCR of the receiver to the intended channel number, for instance 52. More than one device can be programmed as receiver for a given channel number. The programming can be done using a signal as shown in FIG. 5.

Data streams can also be broadcast in which case the first device would send the fourth control traffic signal 50 with the request field set to channel 63, the broadcasting channel and would receive the fifth control traffic signal 58 as a reply from the isochronous resource manager. A broadcast stream is intended to be received by all devices on the network. All the devices on the network should then have an iPCR set to 63. It is furthermore possible that the destination of a stream is not defined by the control traffic. This can for instance take place if a recorder, after requesting a channel and some bandwidth, sets its oPCR to this channel and starts to transmit. Then there is no control traffic identifying a receiver. A receiving device could then scan the different channels and tune to the one, which it first encounters a data stream on.

Data streams are thus allocated bandwidth on the bus according to availability. All the data streams on the first bus are received by the first portal 12 of bridging device 10 on the first terminal 30 from where they are transferred to the first bus transceiving unit 32 for decoding. The first control unit 34 then applies filtering of the streams based on a prioritization scheme, which will be described shortly. Streams to be transferred to the second bus 18 are forwarded to the first medium transceiving unit 36, while streams that are not because of the limited bandwidth of the wireless medium 13 are not forwarded. The first medium transceiving unit 36 then codes streams for sending over the wireless medium and forwards these streams to the antenna for sending to the second portal 14. The second portal 14 receives the data streams via the antenna and the second media transceiving unit 42 decodes the streams and forwards them to the second control unit 44. The second control unit 44 forwards the streams to the second bus transceiving unit 46, which applies encoding for making the streams appropriate for sending on the second bus, from where it is output on the second bus via the second terminal 48. How coding and other types of processing is done is described in specification IEC 61883-5. Wireless media is normally used under coding using Hiperlan 2 coding. These are preferred coding techniques, however it should be realized that these are just examples of standards that can be used. What has been described here is just the transfer in one direction. It should be realized that in the same manner a data stream can be transferred from the second bus to the first bus.

In the first exemplifying embodiment, the first and second buses both have the same bandwidth allowing a certain load of traffic. The bandwidth on the two buses is managed by the same entity: the isochronous resource manager. The buses can however have different bandwidths. For instance, in the preferred embodiment these have a bandwidth in the range 100-400 Mbps. The wireless connection though has a much smaller bandwidth, which is in the range 10-50 Mbps. Because of this for example the first bus can allow handling of a larger amount of streams than what the wireless connection 13 can.

This might be no problem if most of the traffic or streams on the buses is lower than the bandwidth of the wireless medium. In this case all traffic on one side of the bridge is transferred to the other side of the transparent bridge. If the traffic is higher than the bandwidth of the wireless medium while most of the traffic is intended to remain on the local bus from which it is originating, this might be no problem if filtering can be applied in an effective way, that is if all the needed information may be captured from the control traffic and from information made available by the 1394 devices in their CSRs (mainly in their iPCRs and oPCRs). This is not always the case because a receiver may base its decision on the channels that are available on the bus. A receiver can for instance do this by scanning the bus in search for viewable streams. In this latter case, a filtering performed in the bridging device will allow transmission of all streams that have to be transmitted to the other side and a prioritization scheme will help to detect which stream could be transmitted to the other side in order to enable a receiver to base its decision on the streams available on the bus and thus to have a bridge as transparent as possible.

If the traffic is higher than the bandwidth of the wireless medium and if all the traffic is not intended to remain locally, there is thus a need for prioritization. The object of the present invention is therefore to provide such a prioritization of streams to transfer.

In order to describe the invention reference is now being made to FIGS. 1, 2 and 8, where FIG. 8 shows a flow chart of a method according to the invention. The prioritization is based on all traffic in both directions over the wireless medium. The first and second control units 34 and 44 monitor the control traffic respectively on the first bus 16 and on the second buses 18 via respectively the first and second transceiving units 32 and 46 and via respectively the first terminal 30 and the second terminal 48, step 66. If the bus control traffic is not used for setting the priorities, the relevant information is instead obtained by reading CSR registers of the devices on both the buses. It is also possible to use both these ways for obtaining the necessary information for the prioritization.

For traffic present on the first bus 16, the first control unit 34 sets a priority counter X equal to 1, step 67. It thereafter sets up a set of priorities to use when sending streams over the wireless medium. Prioritization is based on relevant information transported in the bus control traffic and/or on relevant information made available by the devices connected to the first bus. It sets a first priority to streams for which the sender is connected to the first bus and thus has its oPCR set to the channel number identifying the stream and which has ordered or for which a controller has ordered at least one device on the second bus 18 to sets its iPCR to the same channel number. In the example given above a stream from the first device 20 to the third device 24 may have such a priority. A second priority is given to streams, which are broadcast streams, i.e. the streams set to channel 63. A third priority is given to streams without any receiver, that is to streams without any corresponding iPCR set on the first or the second bus. A fourth priority is given to all other streams, which include streams known to be provided only for devices on the first bus. The second control unit 44 performs the same type of prioritizing for traffic present on the second bus 18. Thus both the control units set these four priorities, step 68.

Thereafter the algorithm in the first control unit 34 investigates if there is any spare capacity, i.e. the priority counter has not reached a maximum value, step 70. This is also done by the second control unit 44 informing the first control unit 34 of streams on the second bus, corresponding bandwidth and corresponding priority, whereupon the first control unit 34 decides which streams on both the first and second bus are to be transferred via the wireless medium. This priority investigation is performed dynamically in both portals, for instance each time a new stream is established or released via the isochronous resource manager. The medium bandwidth is thus shared by both the portals. The change in state is detected by monitoring the relevant traffic information or by polling the different registers. If there is bandwidth available and if the counter has not reached its final value, step 70, then streams of the first priority are selected for transferral via the medium, step 72, and the counter is increased with one, step 74. Thereafter the method goes back to step 70 and checks if there is bandwidth left and if the counter has not reached its limit. In this way the method continues until either all streams according to all priorities have been transferred or there is a shortage of bandwidth. Naturally streams having the highest priority get transferred first. It should also be noted that the fourth priority includes streams having a receiver and a sender on the same side of the bridge. The reason for transferring them is to make the network as transparent as possible when it is possible and thus to enable a second receiver tuning itself to an available channel by for instance scanning the physical media for viewable streams. In the description above the first control unit 34 was the control unit where the actual selection of streams was being made. Naturally this selection could just as well take place in the second control unit 44.

The invention has many advantages. One is that prioritizing of transfer of streams takes place without the devices having to request transfer or bandwidth from the bridging device. The invention is therefore transparent to the devices. The invention furthermore works well with equipment using the 1394 standard. This has the advantage that it works with legacy devices, that is with devices designed according to the present bus specification and already available on the market. This has also the additional advantage that the devices can be made simpler than they would otherwise need to be. These devices do therefore not have to know how prioritization is done.

The different units in the bridging device are normally provided in the form of one or more processors together with suitable program memory containing appropriate program code for performing the method according to the invention. The software or program code for performing the method according to the invention can also be provided on a computer program product in the form of a computer readable medium, which will perform the method according to the invention when loaded into the bridging device, which is a type of computer. One such medium in the form of a CD Rom 78 is depicted in FIG. 9, although there are many different mediums possible such as diskettes, flash cards or memory sticks. The program code can also be downloaded to the bridging device from some remote computer, with which the network can communicate for instance via the Internet.

There are a number of possible variations to the invention, which can be made in addition to those already mentioned. The different priorities can be varied. For instance the order of the two highest priorities can be switched, in that broadcast streams can get the highest priority and streams with at least one dedicated receiver on the second bus gets second highest priority. The devices provided on the second bus do not all have to be provided there. One, some or all might be connected to the bridging device directly via the wireless medium. These devices might then be visible as a IEEE1394 device on a single bus. In this case the same prioritization scheme could be applied; the functions performed in the second portal should then be implemented in the wireless device itself. The bridging device need furthermore not include the isochronous resource manager function, but this can be provided on some other device. The bridging device can furthermore interconnect several buses (more than two) with each other and each portal associated with a bus would have its own address. In the description there was only one controller described. It should be realized that several controllers can exist in the network. One controller can furthermore control more than one device. The third priority described above was only given for streams where no iPCR setting was made.

It is possible, as an alternative, that it can be found out if a stream could be intended for one specific bus by polling the iPCR registers of all the devices on this specific bus. Here it is investigated if the devices are active or not, that is if iPCRs is frequently changed or not. Then streams originating on a bus having no or fewer active devices than the other bus and for which one oPCR and no IPCR is found gets a priority 3a and the streams originating on the other bus with the majority of active devices gets a priority 3b. The streams with priority 3a then get a higher priority than the stream with priority 3b. These priorities 3a and 3b are however lower than the first and second priorities and higher than the fourth priority. This prioritization can be provided in addition to the previously described providing of the third priority.

The invention has been described in relation to bridges and systems working according to the standard IEEE 1394 and the IEC specification 61883-1. It should furthermore be realized that the invention is in no way limited to this standard and this specification, but can be used on any bridging device interconnecting two buses and where there is a transmission limitation. The invention is thus only to be limited by the following claims.

1. Method of prioritizing transportation of isochronous data streams appearing on at least a first bus (16) of a first type having a first bandwidth to a second bus using a medium (13) having a second medium bandwidth lower than the first bandwidth, comprising the steps of:
monitoring control traffic relating to data streams originating from devices (20, 22, 24, 26, 28) connected to the buses and/or polling or ordering the polling of the devices connected to the buses (20, 22, 24, 26, 28), (step 66),
prioritizing streams for transfer over the medium based on relevant information transported in the control traffic and/or made available by the devices connected to the buses, (step 68), and
transferring streams over the medium based on the prioritizing, (step 72).

2. Method according to claim 1, wherein the medium interconnects the first bus with the second bus (18), which is of the first type having a third bandwidth higher than the second medium bandwidth and the step of transferring comprises transferring data streams to and from the second bus via the medium.

3. Method according to claim 1, wherein the second bus comprises the medium.

4. Method according to claim 1, wherein the step of prioritizing comprises the step of giving a certain priority to streams for which relevant information indicates a sender (50, 58) connected to one of the buses and at least one dedicated receiver (62) connected to the other bus.

5. Method according to claim 4, wherein the step of giving a certain priority to streams for which relevant information indicates a sender on one bus and at least one dedicated receiver on the other bus, comprises giving the priority if the relevant information indicates that a sender on said one bus has an output plug control register setting for a given stream and at least one receiver connected to the other bus has an input plug control register setting for the same given stream.

6. Method according to claim 4, wherein the step of prioritizing includes the step of giving another priority to streams for which relevant information indicates broadcast streams (50, 58) intended for all devices connected to the buses.

7. Method according to claim 6, wherein streams for which relevant information indicates a sender (50, 58) connected to said one bus and at least one dedicated receiver (62) connected to the other bus gets a highest priority and broadcast streams gets a second highest priority.

8. Method according to claim 6, wherein broadcast streams get a highest priority and streams for which control traffic indicate a sender connected to said one bus and at least one dedicated receiver connected to the other bus gets a second highest priority.

9. Method according to claim 6, wherein the step of prioritizing includes the step of giving a third highest priority to streams for which there is no control traffic (62) and/or information made available by the devices connected to the buses indicating a receiver for the stream.

10. Method according to claim 9, wherein the step of polling includes polling registers of devices connected to each bus and further including the step of evaluating each device in term of activity, that is, in term of its potential to become a receiver for a stream that has not yet a dedicated receiver, and the step of giving the third highest priority for a stream includes giving a higher priority, within the third priority, to streams originating on one bus if there are more active devices on the other bus and a lower priority to streams originating on the other bus.

11. Method according to claim 9, wherein the step of prioritizing includes the step of giving a lowest priority to all streams that do not have the third highest priority, are not broadcast streams and are not streams for which relevant information transported in the control traffic or made available by the devices connected to the buses indicates a sender connected to said one bus and at least one dedicated receiver connected to the other bus.

12. Bridging device (10) for prioritizing transportation of isochronous data streams appearing on at least a first bus (16) of a first type having a first bandwidth from devices (20, 22) connected to the first bus to devices (24, 26, 28) connected to a second bus (18) using a medium (13) having a second medium bandwidth lower than the first bandwidth, said bridging device comprising:
at least one first portal (12) comprising:
a first medium transceiving unit (36) for transmitting/receiving data streams over the medium (13),
a first bus transceiving unit (32), and
a first control unit (34) arranged to:
monitor control traffic relating to data streams originating from devices (20, 22) connected to the first bus and/or poll or order the polling of the devices connected to the buses (20, 22, 24, 26, 28),
prioritize streams for transfer over the medium based on relevant information transported (62) in the bus control traffic and/or made available by the devices connected to the buses, and
control transferring of streams over the medium based on the prioritizing.

13. Bridging device (10) according to claim 12, wherein the bridging device is connected to a second bus (18) of the first type having a third bandwidth higher than the second medium bandwidth and further including a second portal (14) comprising a second medium transceiving unit (42) for transmitting/receiving data streams over said medium, a second bus transceiving unit (46), and a second control unit (44).

14. Bridging device according to claim 12, wherein the second bus comprises the medium.

15. Bridging device (10) according to claim 12, wherein a control unit (34, 44) when prioritizing streams is arranged to give a certain priority to streams for which relevant information indicates a sender (50, 58) connected to one of the buses and at least one dedicated receiver (62) connected to the other bus.

16. Bridging device (10) according to claim 15, wherein a control unit (34, 44) when giving said certain priority to streams for which relevant information indicates a sender connected to one bus and at least one dedicated receiver connected to the other bus, is arranged to give the priority if the relevant information indicates that a sender on said one bus has an output plug control register setting for a given stream and at least one receiver connected to the other bus has an input plug control register setting for the same given stream.

17. Bridging device (10) according to claim 15, wherein a control unit (34, 44) when prioritizing streams is arranged to give another priority to broadcast streams.

18. Bridging device (10) according to claim 17, wherein a control unit is arranged to assign a highest priority to streams for which relevant information indicate a sender (50, 58) connected to said one bus and at least one dedicated receiver (62) connected to the other bus (16) and a second highest priority to broadcast streams.

19. Bridging device (10) according to claim 17, wherein a control unit is arranged to assign a highest priority to broadcast streams and a second highest priority to streams for which relevant information indicate a sender connected to said one bus and at least one dedicated receiver connected to the other bus.

20. Bridging device (10) according to claim 17, wherein a control unit (34) when prioritizing streams is arranged to give a third highest priority to streams for which relevant information transported in the control traffic and/or made available by the devices connected to the buses indicates there is no receiver assigned for the stream.

21. Bridging device (10) according to claim 20, wherein a control unit (34) is arranged to poll or order polling of device registers and is further arranged to evaluate each device in term of activity, that is, in term of its potential to become a receiver for a stream that has not yet a dedicated receiver, and in giving the third highest priority to streams originating on one bus if there are more active devices on the other bus and a lower priority to streams originating on the other bus.

22. Bridging device (10) according to claim 20, wherein the control unit (34) when prioritizing streams is arranged to give a lowest priority to all streams that do not have the third highest priority, are not broadcast streams and are not streams for which relevant information indicates a sender connected to said one bus and at least one dedicated receiver connected to the other bus.

23. Bridging device according to claim 13, wherein the second control unit of the second portal transmits information about set priorities and bandwidth required for streams on the second bus to the first control unit in the first portal, which information is used by the first control unit for the control of transferring of streams.

24. Bridging device according to claim 13, where there are furthermore more than two buses and a corresponding number of portals in the bridging device, each portal being connected to one bus.

25. Network of devices communicating with each other comprising:
a first bus (16) of a first type having a first bandwidth,
at least one first device (20, 22) connected to the first bus,
at least one second device (24, 26, 28) connected to a second bus (18) and communicating with devices of the first bus using a medium (13) having a second medium bandwidth lower than the first bandwidth, and
a bridging device (10) connected to the first bus and comprising:
at least one first portal (12) comprising:
a medium transceiving unit (36) for transmitting/receiving data streams over the medium (13),
a first bus transceiving unit (32), and
a first control unit (34) arranged to:
monitor control traffic relating to isochronous data streams originating from devices (20, 22) connected to the first bus and/or poll or order the polling of the devices connected to the buses (20, 22, 24, 26, 28),
prioritize streams for transfer over the medium based on relevant information transported (62) in the bus control traffic and/or made available by the devices connected to the buses, and
control transferring of streams over the medium based on the prioritizing.

26. Network according to claim 23, wherein the second bus (18) is of the first type having a third bandwidth higher than the second medium bandwidth to which said at least one second device is connected and said bridging device (10) further including at least one second portal (14) comprising a second medium transceiving unit (42) for transmitting/receiving data streams over said medium, a second bus transceiving unit (46), and a second control unit (44).

27. Computer program product (78), for prioritizing of transportation of isochronous data streams appearing on at least a first bus of a first type having a first bandwidth to a second bus using a medium having a second medium bandwidth lower than the first bandwidth, to be used on a computer provided between said first bus and the medium, comprising a computer readable medium having thereon:
computer program code means, to make the computer execute, when said program is loaded in the computer:
monitor control traffic relating to data streams originating from devices connected to the first bus and/or poll or order the polling of the devices connected to the buses,
prioritize streams for transfer over the medium based on relevant information transported in the bus control traffic and/or made available by the devices connected to the buses, and
control transfer of streams over the medium based on the prioritizing.

28. Computer program element for prioritizing of transportation of isochronous data streams appearing on at least a first bus of a first type having a first bandwidth to a second bus using a medium having a second medium bandwidth lower than the first bandwidth, to be used on a computer provided between said first bus and the medium, said computer program element comprising:
computer program code means, to make the computer execute, when said program is loaded in the computer:
monitor control traffic relating to data streams originating from devices connected to the first bus and/or poll or order the polling of the devices connected to the buses,
prioritize streams for transfer over the based on relevant information transported in the bus control traffic and/or made available by the devices connected to a bus, and
control transfer of streams over the medium based on the prioritizing.
